(19) United States
(12) Patent Application Publication
(10) Pub. No.: US 2018/0321807 A1
(43) Pub. Date: Nov. 8, 2018

(54) SYSTEMS AND METHODS FOR TAILORED CONTENT PROVISION

(71) Applicant: ServiceNow, Inc., Santa Clara, CA (US)

(72) Inventors: Bruce Ward, Los Gatos, CA (US); Aditya Ramamurthy, Hyderabad (IN); Bhupal Lambodhar, San Diego, CA (US); Raghavan Muthuraman, Hyderabad (IN)

(21) Appl. No.: 15/643,217

(22) Filed: Jul. 6, 2017

(30) Foreign Application Priority Data
May 6, 2017 (IN) 201711016025

(51) Int. Cl. G06F 3/0484; G06F 9/44

(52) U.S. Cl. CPC G06F 3/0484; G06F 3/0486; G06F 9/4446

(57) ABSTRACT

Systems and methods for identifying focus areas and/or related content based upon digital content interactions are provided. A graphical-user-interface (GUI) renders digital content. As interactions with the digital content are observed, focus areas area identified based upon characteristics of the interactions. Notification of the focus areas and/or presentation of digital content offerings are presented based upon the determined focus areas.

### CROSS-REFERENCE TO RELATED APPLICATION

This application claims priority to and the benefit of Indian Patent Application No. 201711016025, entitled “SYSTEM AND METHODS FOR TAILORED CONTENT PROVISION”, filed May 6, 2017, which is herein incorporated by reference in its entirety.

### TECHNICAL FIELD

The present disclosure relates in general to systems, methods, and apparatuses for visualization features of a graphical-user-interface (GUI). More specifically, the present disclosure is related to systems and methods for generating and/or rendering content recommendations based upon observed interaction with guided tours and other documents facilitated by a remote instance for subsequent visualization at a client device.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Computer resources hosted in distributed computing (e.g., cloud-computing) environments may be disparately located with different resources potentially having their own functions, properties, and/or permissions. Such resources may include hardware resources (e.g. computing devices, switches, etc.) and software resources (e.g. database applications). These resources may be used to collect and store data at various times related to a variety of measurable properties, including network, hardware, or database performance properties measured at different times. As systems for collecting data become more readily available and the costs for storage hardware continue to decrease, the amount of data that these computer resources are capable of collecting is increasing. For instance, in addition to collecting raw data more frequently, metadata associated with the time in which the raw data has been generated or acquired may also be stored for a given data set.

Although the capabilities of computer resources for collecting and storing more data continues to expand, the vast amount of collected data has resulted in more-complex GUIs that provide a significant number of interactive objects. In particular, the magnitude of available data (and corresponding interactive GUI objects) may result in difficulties in understanding what each of the various objects represents, how they are intended to be interacted with, etc. While, documents, such as images and videos may demonstrate functions of the interactive objects, as the GUIs expand, it may be difficult to find particular relevant demonstrations.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Information Technology (IT) networks may include a number of computing devices, server systems, databases, and the like that generate, collect, and store information. Graphical-user-interfaces may provide interactive objects, which enable usage of this data. As GUIs become increasingly complex, it may be more difficult to discern certain characteristics of the GUIs' interactive objects.

With this in mind, an IT system may include a guided tour designer (GTD) that enables creation of a guided tour of certain features of a graphical-user-interface (GUI). The guided tour may provide insight into various interactive objects presented by the GUI, resulting in a clearer understanding of GUI and its interactive objects.

Guided tours and other documents (e.g., click-through demonstrations, images, and/or videos may be generated to illustrate certain features of the GUIs. However, to avoid inundation with a multitude of demonstrative content, a system may monitor interaction with the instance GUIs, to discern a focus of the interaction. For example, particular portions of the GUIs may be associated with meta-data. Interaction with these particular portions may be associated with the meta-data, and a focus of the interaction may be determined based upon the distribution of the meta-data. The discerned focus may be used to derive subsequent content recommendations/provision.

As will be discussed in more detail below, interactions may be weighted, proportioning a more significant portion of the distribution to certain sets of interactions over other interactions. This enables increased focus accuracy, resulting in better content recommendations/provision.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

The description herein makes reference to the accompanying drawings, wherein like reference numerals refer to like parts throughout the several views.

FIG. 1A is a block diagram of a generalized distributed computing system utilizing a cloud service and databases, in accordance with an embodiment;

FIG. 1B is a block diagram illustrating portions of the system of FIG. 1A in more detail, in accordance with an embodiment;

FIG. 1C is flowchart, illustrating a process for providing accurate content recommendations using the system of claim 1A, in accordance with an embodiment;

FIG. 2 is a block diagram of a computing device utilized in the distributed computing system of FIG. 1, in accordance with an embodiment;

FIG. 3 is a flowchart that illustrates a process for generating a guided tour, in accordance with an embodiment;

FIG. 4 is a diagram illustrating a graphical-user-interface where a request for generating a guided tour is initiated, in accordance with an embodiment;

FIG. 5 is a diagram illustrating a graphical-user-interface where a prompt for characteristics of a new guided tour is rendered, in accordance with an embodiment;

FIG. 6 is a diagram illustrating a graphical-user-interface where interactive objects for the new guided tour are rendered, in accordance with an embodiment;

FIG. 7 is a diagram illustrating a graphical-user-interface where a callout menu is provided and facilitation of a callout association with an interactive object is provided, in accordance with an embodiment;

FIG. 8 is a diagram illustrating a graphical-user-interface where a callout characteristic prompt is provided, in accordance with an embodiment;

FIG. 9 is a diagram illustrating a graphical-user-interface where an association is generated and sequentially stored, in accordance with an embodiment;

FIG. 10 is a diagram illustrating a graphical-user-interface where a second callout characteristic prompt is provided based upon a second association request, in accordance with an embodiment;

FIG. 11 is a diagram illustrating a graphical-user-interface where an association request between a callout and an interactive tab is provided, in accordance with an embodiment;

FIG. 12 is a diagram illustrating a graphical-user-interface where an association request between a callout and an interactive button is provided, in accordance with an embodiment;

FIG. 13 is a diagram illustrating a graphical-user-interface where a set of complete sequential associations are stored and a prior association edit request is facilitated, in accordance with an embodiment;

FIG. 14 is a diagram illustrating a graphical-user-interface where a callout characteristic edit prompt is provided, in accordance with an embodiment; and

FIG. 15 is a diagram illustrating a graphical-user-interface where a playback preview is requested, in accordance with an embodiment;

FIGS. 16A-F are diagrams illustrating playback progression of a guided tour, in accordance with an embodiment;

FIG. 17 is a diagram illustrating a graphical-user-interface with automatic incorporate of a guided tour in an embedded help section, in accordance with an embodiment;

FIG. 18 is a block diagram illustrating a graphical-user-interface for providing digital content, in accordance with an embodiment;

FIG. 19 is a block diagram illustrating a graphical-user-interface for providing a click-through demonstration, in accordance with an embodiment;

FIG. 20 is a block diagram illustrating a graphical-user-interface for providing video digital content, in accordance with an embodiment;

FIGS. 21 and 22 are block diagrams illustrating a graphical-user-interface for providing category-specific digital content, in accordance with an embodiment;

FIG. 23 is a block diagram illustrating a graphical-user-interface for providing role-based digital content, in accordance with an embodiment; and

FIG. 24 is a block diagram illustrating a graphical-user-interface for providing a demonstration instance, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The following discussion relates to generation and presentation of guided tours and document views in an Information Technology (IT) monitoring and/or reporting system. However, this is not meant to limit the current techniques to IT systems. Indeed, the current techniques may be useful in a number of different contexts. For example the current techniques may be applied to Human Resources (HR) systems or any system that may benefit from guided tours and/or rendered document views.

Keeping this in mind, the discussion now turns to an Information Technology (IT)-centered example. IT devices are increasingly important in an electronics-driven world in which various electronics devices are interconnected within a distributed context. As more functions are performed by services using some form of distributed computing, the complexity of IT network management increases. As management complexities increase, GUIs for completing the complex management may increase. Further, when documents are retrieved via download, data inundation may result in significant depletion on client device storage resources. Further, document downloads may reduce data security by allowing local data manipulation of documents.

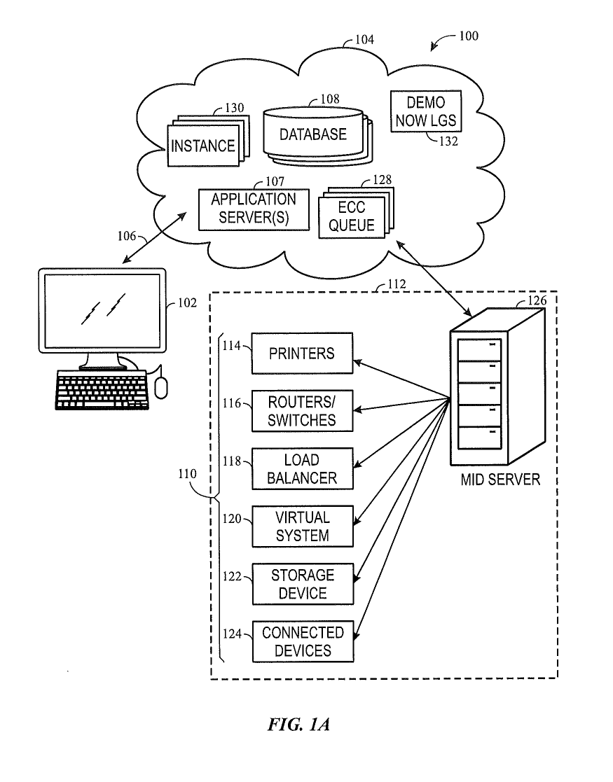

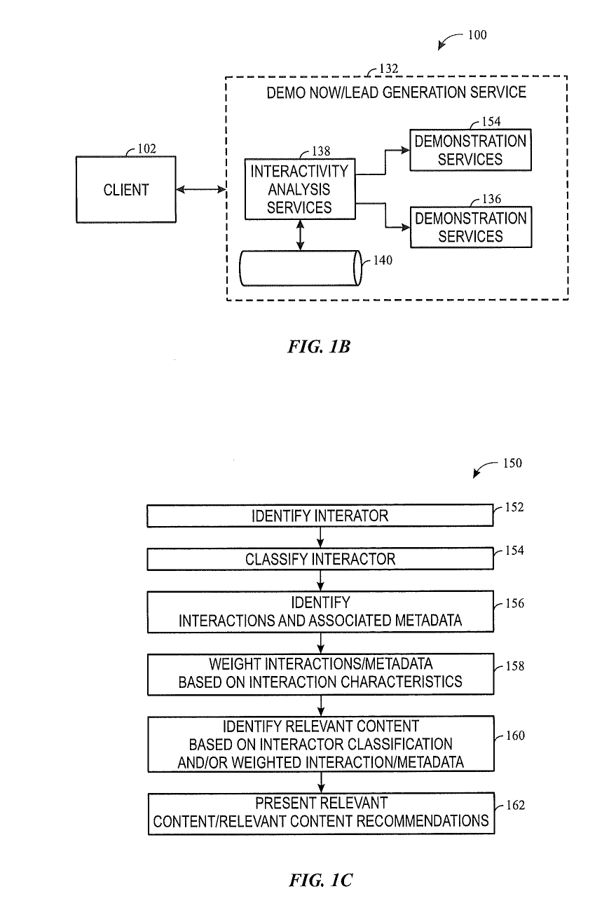

By way of introduction to the present concepts and to provide context for the examples discussed herein, FIG. 1A is a block diagram of a system 100 that utilizes a distributed computing framework, which may perform one or more of the techniques described herein. As illustrated in FIG. 1, a client 102 communicates with a cloud service 104 over a communication channel 106. The client 102 may include any suitable computing system. For instance, the client 102 may include one or more computing devices, such as a mobile phone, a tablet computer, a laptop computer, a notebook computer, a desktop computer, or any other suitable computing device or combination of computing devices. The client 102 may include client application programs running on the computing devices. The client 102 can be implemented using a single physical unit or a combination of physical units (e.g., distributed computing) running one or more client application programs. Furthermore, in some embodiments, a single physical unit (e.g., server) may run multiple client application programs simultaneously.

The cloud service 104 may include any suitable number of computing devices (e.g., computers) in one or more locations that are connected together using one or more networks. For instance, the cloud service 104 may include various computers acting as servers in datacenters at one or more geographic locations where the computers communicate using network and/or Internet connections. The communication channel 106 may include any suitable communication mechanism for electronic communication between the client 102 and the cloud service 104. The communication channel 106 may incorporate local area networks (LANs), wide area networks (WANs), virtual private networks (VPNs), cellular networks (e.g., long term evolution networks), and/or other network types for transferring data between the client 102 and the cloud service 104. For example, the communication channel 106 may include an Internet connection when the client 102 is not on a local network common with the cloud service 104. Additionally or alternatively, the communication channel 106 may include network connection sections when the client and the cloud service 104 are on different networks or entirely using network connections when the client 102 and the cloud service 104 share a common network. Although only a single client 102 is shown connected to the cloud service 104, it should be noted that cloud service 104 may connect to multiple clients (e.g., tens, hundreds, or thousands of clients).

Through the cloud service 104, the client 102 may connect to various devices with various functionality, such as gateways, routers, load balancers, databases, application servers running application programs on one or more nodes, or other devices that may be accessed via the cloud service 104. For example, the client 102 may connect to an application server 107 and/or one or more databases 108 via the cloud service 104. The application server 107 may include any computing system, such as a desktop computer, laptop computer, server computer, and/or any other computing device capable of providing functionality from an application program to the client 102. The application server 107 may include one or more application nodes running application programs whose functionality is provided to the client via the cloud service 104. The application nodes may be implemented using processing threads, virtual machine instantiations, or other computing features of the application server 107. Moreover, the application nodes may store, evaluate, or retrieve data from the databases 108 and/or a database server.

The databases 108 may contain a series of tables containing information about assets and enterprise services controlled by a client 102 and the configurations of these assets and services. The assets and services include configuration items (CIs) 110 that may be computers, other devices on a network 112 (or group of networks), software contracts and/or licenses, or enterprise services. The CIs 110 may include hardware resources (such as server computing devices, client computing devices, processors, memory, storage devices, networking devices, or power supplies); software resources (such as instructions executable by the hardware resources including application software or firmware); virtual resources (such as virtual machines or virtual storage devices); and/or storage constructs (such as data files, data directories, or storage models). As such, the CIs 110 may include a combination of physical resources or virtual resources. For example, the illustrated embodiment of the CIs 110 includes printers 114, routers/switches 116, load balancers 118, virtual systems 120, storage devices 122, and/or other connected devices 124. The other connected devices 124 may include clusters of connected computing devices or functions such as data centers, computer rooms, databases, or other suitable devices. Additionally or alternatively, the connected devices 124 may include facility-controlling devices having aspects that are accessible via network communication, such as heating, ventilation, and air conditioning (HVAC) units, fuel tanks, power equipment, and the like. The databases 108 may include information related to CIs 110, attributes (e.g., roles, characteristics of elements, etc.) associated with the CIs 110, and/or relationships between the CIs 110.

In some embodiments, the databases 108 may include a configuration management database (CMDB) that may store the data concerning CIs 110 mentioned above along with data related to various IT assets that may be present within the network 112. In addition to the databases 108, the cloud service 104 may include one or more other database servers. The database servers are configured to store, manage, or otherwise provide data for delivering services to the client 102 over the communication channel 106. The database server may include one or more additional databases that are accessible by the application server 107, the client 102, and/or other devices external to the additional databases. By way of example, the additional databases may include a relational database and/or a time series database. The additional databases may be implemented and/or managed using any suitable implementations, such as a relational database management system (RDBMS), a time series database management system, an object database, an extensible markup language (XML) database, a configuration management database (CMDB), a management information base (MIB), one or more flat files, and/or or other suitable non-transient storage structures. In some embodiments, more than a single database server may be utilized. Furthermore, in some embodiments, the cloud service 104 may have access to one or more databases external to the cloud service 104 entirely.

In the depicted topology, access to the CIs 110 from the cloud service 104 is enabled via a management, instrumentation, and discovery (MID) server 126 via an External Communications Channel (ECC) Queue 128. The MID server 126 may include an application program (e.g., Java application) that runs as a service (e.g., Windows service or UNIX daemon) that facilitates communication and movement of data between the cloud service 104 and external applications, data sources, and/or services. The MID service 126 may be executed using a computing device (e.g., server or computer) on the network 112 that communicates with the cloud service 104. As discussed below, the MID server 126 may periodically or intermittently use discovery probes to determine information on devices connected to the network 112 and return the probe results back to the cloud service 104. In the illustrated embodiment, the MID server 126 is located inside the network 112 thereby alleviating the use of a firewall in communication between the CIs 110 and the MID server 126. However, in some embodiments, a secure tunnel may be generated between a MID server 126 running in the cloud service 104 that communicates with a border gateway device of the network 112.

The ECC queue 128 may be a database table that is typically queried, updated, and inserted into by other systems. Each record in the ECC queue 128 is a message from an instance in the cloud service 104 to a system (e.g., MID server 126) external to the cloud service 104 that connects to the cloud service 104 or a specific instance 130 running in the cloud service 104 or a message to the instance from the external system. The fields of an ECC queue 128 record include various data about the external system or the message in the record.

Although the system 100 is described as having the application servers 107, the databases 108, the ECC queue 128, the MID server 126, and the like, it should be noted that the embodiments disclosed herein are not limited to the components described as being part of the system 100. Indeed, the components depicted in FIG. 1A are merely provided as example components and the system 100 should not be limited to the components described herein. Instead, it should be noted that other types of server systems (or computer systems in general) may communicate with the cloud service 104 in addition to the MID server 126 and/or may be used to implement the present approach.

Further, it should be noted that server systems described herein may communicate with each other via a number of suitable communication protocols, such as via wired communication networks, wireless communication networks, and the like. In the same manner, the client 102 may communicate with a number of server systems via a suitable communication network without interfacing its communication via the cloud service 104.

In addition, other methods for populating the databases 108 may include directly importing the CIs or other entries from an external source, manual import by users entering CIs o or other entries via a user interface, and the like. Moreover, although the details discussed above are provided with reference to the CMDB, it should be understood that the embodiments described herein should not be limited to being performed with the CMDB. Instead, the present systems and techniques described herein may be implemented with any suitable database.

Additionally, the system 100 may include demonstration services 132, which may present content (e.g., guided tours, videos, click-through demonstrations, etc.) which may be useful to illustrate certain features/functions of portions of GUIs of the system 100. As will be discussed in more detail below, the demonstration services 132 may provide interactivity monitoring that may discern a likely interest focus based upon interactivity with the demonstration services 132. The interest focus may be used to identify future content recommendations and/or future content to present to a user.

### Content Recommendations

FIG. 1B illustrates a more detailed view of the demonstration services 132 of FIG. 1A. As illustrated, the client 102 may interact with the demonstration services 132. For example, the client may interact with demonstrations (e.g., provided by the demonstration services 134) and/or may view or otherwise interact with other digital content (e.g., videos, images, etc.) (e.g., provided by the digital content provision services 136).

Interactivity analysis services 138 may monitor for interaction between the client 102 and content, such as demonstrations provided by the demonstration services 134 and/or digital content (e.g., videos, images, etc.) provided by the digital content provision services 136. As will be discussed in more detail below, the interactivity analysis services 138 may identify content that may be relevant based upon interaction between the client 102 and the content. The interactions and/or the identified content may be stored in the data store 140, such that, when desirable, new content and/or content recommendations may be provided to the client 102, based upon the interactions.

FIG. 1C is a flowchart, illustrating a process 150 for providing content/content recommendations based upon observed interactions, in accordance with an embodiment. In the process 150, a particular interactor may be identified (block 152). For example, a user associated with client 120 may register with the system 100, resulting in generation of a user profile. By identifying the interactor (e.g., the user), interactions of the user may be aggregated across multiple sessions, resulting in an accumulation of interactions with content, which may be used by the demonstration services 132 in determining relevant content applicable to the user. For example, the interactions and/or relevant content associated with the interactions may associated with the user's profile and stored (e.g., in the data store 140 of FIG. 1B). Additionally and/or alternatively, a cookie or other tracking mechanism may be used to aggregate and associate interactions with a user/user profile.

The interactor may also be classified as a particular type of interactor (block 154). For example, the interactor may be classified as a potential new customer, a potential partner, a current customer, and/or a current partner. For example, partners may include users that design add-ons or other third-party features for the system 100, whereas customers may include users that take advantage of services of the system 100.

Additionally or alternatively, the classification of the interactor may be based upon a role of the interactor. For example, a technical support role and. a network administrator role may be responsible for vastly different tasks. By classifying the interactor via a role, additional useful information pertaining to relevant content may be gleaned. In one embodiment, information for making such a classification may be acquired via a GUI poll and associated with the user profile. In some embodiments, the classification may be inferred based upon interactions or other available information. For example, if an interactor typically interacts with digital content related to a network administrator's role, the system 100 may infer that the interactor holds a network administrator role. Further, in some embodiments, an access permissions role may be used to classify the interactor based upon a role.

Additionally, a particular instance that is accessed may provide information useful for classification. For example, if a developer instance is accessed, such access may suggest that the interactor is a developer and/or tester rather than a high-level manager, such as Chief Executive Officer. Accordingly, based upon characteristics of particular access criteria, certain role inferences may be made.

In some embodiments, classification of the interactor may be determined based at least in part upon a speed of interaction with content. For example, if an interactor progresses at a fast pace through a click-through demonstration (e.g., above a pre-determined threshold speed), this may indicate that the interactor is familiar with at least portions of the feature being demonstrated. However, when an interactor progress slowly (e.g., below a pre-determined threshold speed), this may indicate that the interactor is likely unfamiliar with at least portions of the feature being demonstrated.

The process 150 continues by identifying interactions of the interactor and determining associated meta-data related to the interactions (block 156). For example, the interactivity analysis services 138 may identify interactions, by the interactor, with specific portions of a demonstration of a GUI, specific video, text documents, or images.

Machine-readable meta-data may be associated with the specific portions of a demonstration of a GUI, specific videos, text documents, and/or images, which may provide an indication of particular topics of the specific portions of a demonstration of a GUI, specific videos, text documents, and/or images. Accordingly, by interpreting the meta-data associated with the interacted-with content, the interactivity analysis services 138 may discern possible focus areas of interest.

Characteristics of the interactions may illustrate more likely interest than other characteristics. Accordingly, in some embodiments, the focus areas of interest (e.g., discerned based upon the meta-data associated with the interacted-with content) may be weighted (block 158). For example, consuming content in its entirety may indicate more interest than merely consuming a portion of content. Further, interacting with content for a longer period of time may indicate more interest than interacting with content for a shorter period of time. Repeated consumption of content may indicate more interest than merely consuming content once. Interactive searching of content (e.g., using a keyword search to find interacted-with content) may indicate more interest than merely browsing and interacting with content. Sharing content may indicate more interest than merely consuming content. Further, requesting communication (e.g., via a “Contact Us” link) and/or providing feedback after consuming content may indicate more interest than simply consuming content.

Based upon the difference in likelihood of interest based upon these interaction characteristics, the interactions and/or metadata may be weighted, resulting in a distribution of meta-data accounting for the various characteristics of the interactions and their potential for indicating interest.

Relevant content for subsequent presentation and/or recommendation may be identified based upon the weighted interaction and/or metadata and/or based upon the interactor classification (block 160). For example, in some embodiments, the relevant content may be identified based upon a metadata from the interactions that has the highest weighted distribution. Further in some embodiments, the magnitude of the weighted distribution may be used in conjunction with the interactor classification. For example, if the weighted metadata suggests two focus areas of interest, one associated with a network administrator role and one associated with a developer role, a classification of the interactor based upon role may indicate which of the two focus areas is more relevant. In another example, if a single focus area is present, but content for the focus area includes beginner content and advanced content, a classification based upon the interactor's experience level with a product may determine whether the beginner content or the advanced content should be recommended/presented.

Once the relevant content is identified, the relevant content may be presented and/or recommended (block 162). For example, in some embodiments, new content offerings may be provided directly to the interactor, e.g., via a GUI presented at the client 102. In some embodiments, an email may be provided to the interactor (e.g., as discerned from the interactor's user profile), indicating particular content that the interactor may be interested in.

In some embodiments, a sales representative or other entity may receive a progressive profile, indicating basic information, such as a user name, address, telephone number, etc. associated with the interactor's user profile. Further, the relevant content and/or focus areas may be provided. In addition, an indication of the interactor's interactions may be provided to the sales representative. This may enable the sales representative to follow up with the interactor, providing, via phone or other communications mechanism, information pertaining to the focus areas, the relevant content recommendations, etc.

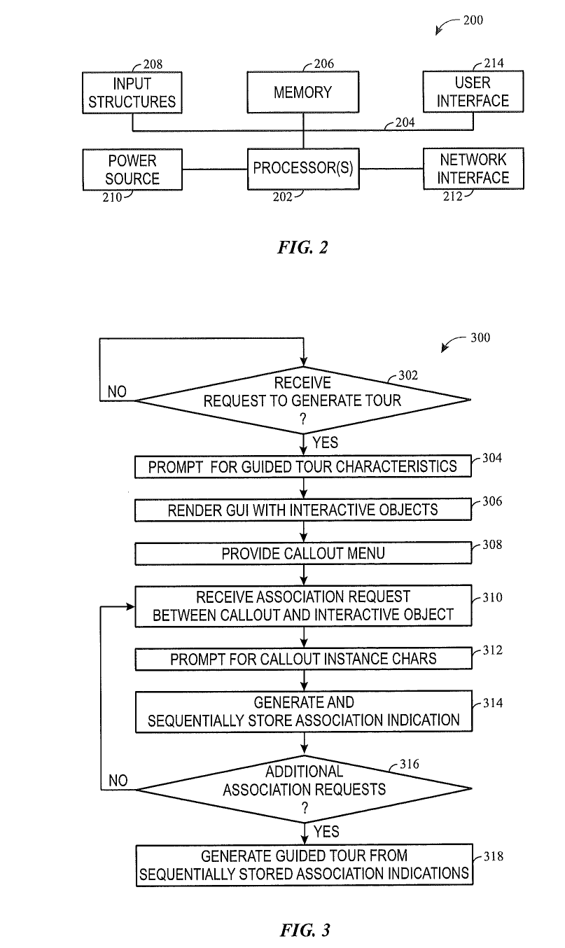

To perform one or more of the operations described herein, the client 102, the application servicer 107, the MID server 126, the demonstration services 130, and other server or computing system described herein may include one or more of the computer components depicted in FIG. 2. FIG. 2 generally illustrates a block diagram of example components of a computing device 200 and their potential interconnections or communication paths, such as along one or more busses. As briefly mentioned above, the computing device 200 may be an embodiment of the client 102, the application server 107, a database server (e.g., databases 108), other servers or processor-based hardware devices present in the cloud service 104 (e.g., server hosting the ECC queue 128), a device running the MID server 126, and/or any of the CIs. As previously noted, these devices may include a computing system that includes multiple computing devices and/or a single computing device, such as a mobile phone, a tablet computer, a laptop computer, a notebook computer, a desktop computer, a server computer, and/or other suitable computing devices.

As illustrated, the computing device 200 may include various hardware components. For example, the device includes one or more processors 202, one or more busses 204, memory 206, input structures 208, a power source 210, a network interface 212, a user interface 214, and/or other computer components useful in performing the functions described herein.

The one or more processors 202 may include processors capable of performing instructions stored in the memory 206. For example, the one or more processors may include microprocessors, system on a chips (SoCs), or any other suitable circuitry for performing functions by executing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206. Moreover, the functions of the one or more processors 202 may be distributed across multiple processors in a single physical device or in multiple processors in more than one physical device. The one or more processors 202 may also include specialized processors, such as a graphics processing unit (GPU).

The one or more busses 204 includes suitable electrical channels to provide data and/or power between the various components of the computing device. For example, the one or more busses 204 may include a power bus from the power source 210 to the various components of the computing device. Additionally, in some embodiments, the one or more busses 204 may include a dedicated bus among the one or more processors 202 and/or the memory 206.

The memory 206 may include any tangible, non-transitory, and computer-readable storage media. For example, the memory 206 may include volatile memory, non-volatile memory, or any combination thereof. For instance, the memory 206 may include read-only memory (ROM), randomly accessible memory (RAM), disk drives, solid state drives, external flash memory, or any combination thereof. Although shown as a single block in FIG. 2, the memory 206 can be implemented using multiple physical units in one or more physical locations. The one or more processor 202 accesses data in the memory 206 via the one or more busses 204.

The input structures 208 provide structures to input data and/or commands to the one or more processor 202. For example, the input structures 208 include a positional input device, such as a mouse, touchpad, touchscreen, and/or the like. The input structures 208 may also include a manual input, such as a keyboard and the like. These input structures 208 may be used to input data and/or commands to the one or more processors 202 via the one or more busses 204. The input structures 208 may alternative or additionally include other input devices. For example, the input structures 208 may include sensors or detectors that monitor the computing device 200 or an environment around the computing device 200. For example, a computing device 200 can contain a geospatial device, such as a global positioning system (GPS) location unit. The input structures 208 may also monitor operating conditions (e.g., temperatures) of various components of the computing device 200, such as the one or more processors 202.

The power source 210 can be any suitable source for power of the various components of the computing device 200. For example, the power source 210 may include line power and/or a battery source to provide power to the various components of the computing device 200 via the one or more busses 204.

The network interface 212 is also coupled to the processor 202 via the one or more busses 204. The network interface 212 includes one or more transceivers capable of communicating with other devices over one or more networks (e.g., the communication channel 106). The network interface may provide a wired network interface, such as Ethernet, or a wireless network interface, such an 802.11, Bluetooth, cellular (e.g., LTE), or other wireless connections. Moreover, the computing device 200 may communicate with other devices via the network interface 212 using one or more network protocols, such as Transmission Control Protocol/Internet Protocol (TCP/IP), power line communication (PLC), Wi-Fi, infrared, and/or other suitable protocols.

A user interface 214 may include a display that is configured to display images transferred to it from the one or more processors 202. The display may include a liquid crystal display (LCD), a cathode-ray tube (CRT), a light emitting diode (LED) display, an organic light emitting diode display (OLED), or other suitable display. In addition and/or alternative to the display, the user interface 214 may include other devices for interfacing with a user. For example, the user interface 214 may include lights (e.g., LEDs), speakers, and the like.

With the foregoing in mind, the discussion now turns to various content where interaction monitoring may be used to identify focus areas of interest, such that future relevant content recommendations may be discerned. Further, the suggested content may be content of similar types as the content monitored for interactivity.

### Guided Tours

Turning first to a discussion of guided tours, FIG. 3 is a flowchart that illustrates a process 300 for generating a guided tour, in accordance with an embodiment. The guided tour may provide one or more graphical callouts along various steps in a process facilitated by a graphical-user-interface (GUI) of a provided service. For example, the guided tour may provide tips as a user enters data into forms provided in the GUI, may indicate particular instructions regarding certain features provided by the GUI, etc. Since each guided tour typically involves a particular provided service and/or process, meta-data related to the particular provided service and/or process may be associated with the guided tour. Upon subsequent interaction with the guided tour by an interactor, the meta-data may be used in identifying a focus area as the particularly provided service and/or process. Further, as will be discussed in more detail below, the callouts may be associated with various interactive objects of a GUI. Accordingly, meta-data identifying the various interactive objects may be associated with interaction with these callouts. Additionally, an amount of time spent on a particular callout, repeated interaction with a particular callout, etc. may be used in weighting the associated meta-data.

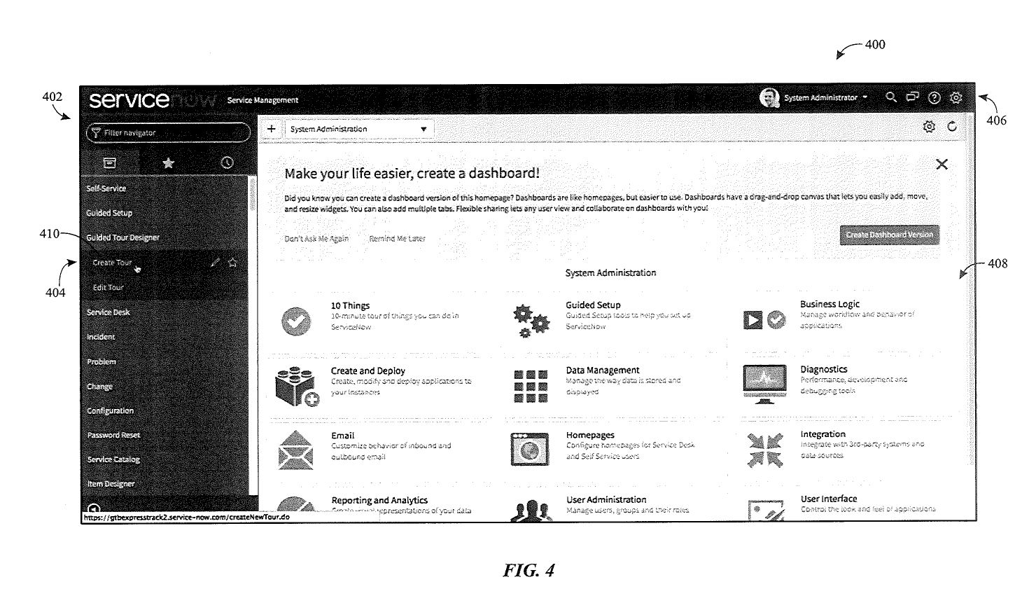

The process 300 begins by polling for a request to generate a guided tour (decision block 302). If a request to generate a guided tour is not detected, the system may continue to poll for such a request. FIG. 4 is a diagram illustrating a graphical-user-interface (GUI) 400 where a request for generating a guided tour is initiated, in accordance with an embodiment. The GUI 400 may be associated with an IT application, HR application, etc.

In the GUI 400, a sidebar 402 includes an option 404 for creating a tour via a guided tour designer. In additional and/or alternative embodiments, an option 404 for creating a tour may be provided elsewhere, such as in the top bar 406, in the main body 408, etc. Upon selection of the option 404 (e.g., via the pointer 410), the request for generation of the guided tour may be generated and/or detected.

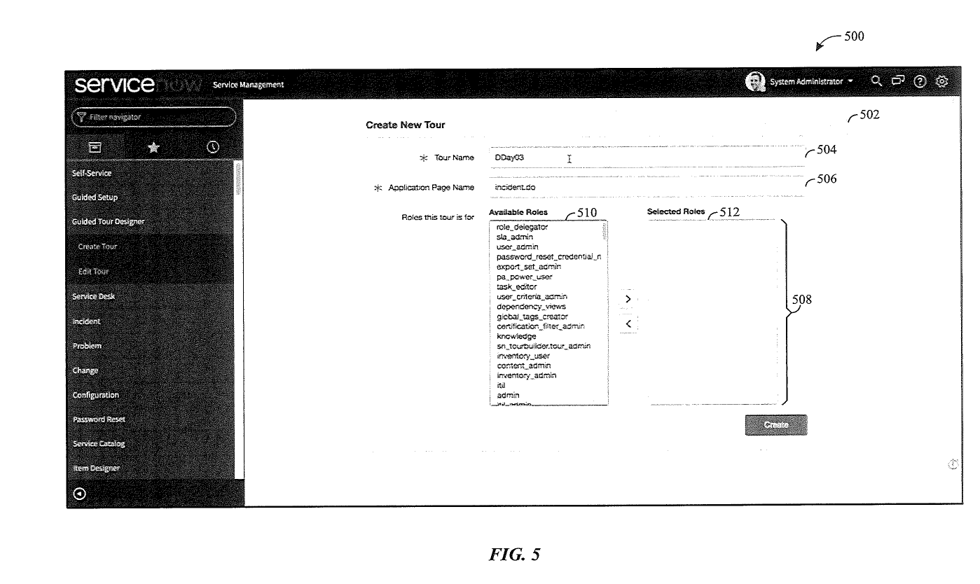

Returning to FIG. 3, the process 300 continues by rendering a GUI that prompts for particular characteristics of the guided tour (block 304). FIG. 5 is a diagram illustrating a GUI 500 where a prompt 502 for characteristics of a new guided tour is rendered, in accordance with an embodiment. The prompt 502 includes a Tour Name field 504 for inputting a name to be associated with the new guided tour. For example, in the illustrated embodiment, the new tour has been named “DDay03”.

Further, the prompt 502 includes an Application Page Name field 506, which is used to input a particular page of a GUI that the guided tour will take place on. As will be discussed in more detail below, the guided tour, when being generated and/or played, will render the page and its interactive objects such that callouts can be associated and/or played back on the interactive objects. For example, in the illustrated embodiment, the guided tour “DDay03” is associated with the incident.do page (e.g., of the IT application mentioned above).

Additionally, the roles section 508 enables the selection of particular roles that the guided tour will be available for. Available roles box 510 may provide a listing of all available role types, such as a task editor, an inventory administrator, a role delegator, etc. When at least one role is selected (e.g., by moving a role from box 510 into selected roles box 512), the guided tour will be available for the selected roles. In some embodiments, if no roles are selected (e.g., by transferring the roles into the selected roles box 512) the guided tour may be available for all roles. In alternative embodiments, when no role is selected, the guided tour is not available for any role. Once the input of the guided tour characteristics is complete (e.g., as indicated by selecting the Create button 514), the process 300 of FIG. 3 may continue.

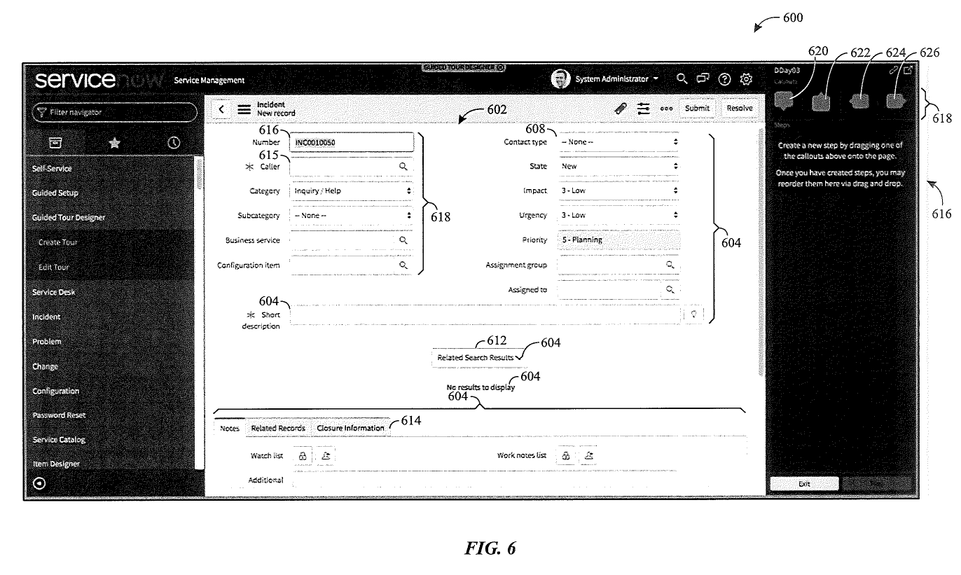

Returning to FIG. 3, the process 300 continues by rendering a GUI with the page indicated in the Application Page Name field 506 of FIG. 5, along with the page's interactive objects (block 306). Additionally, a callout menu is provided by the GUI (block 308). FIG. 6 is a diagram illustrating a GUI 600 rendering the Application Page 602 (e.g., the incident.do page in the current example) and the associated interactive objects 604 for the new guided tour, in accordance with an embodiment. As illustrated, the interactive objects 604 may include any number of page elements. For example, the interactive objects 604 may include text fields, such as text field 606, a selectable list, such as selectable list 608, a query field, such as query field 610, a button, such as button 612, tabs, such as tabs 614, etc.

Additionally, a guided tour menu 616 is presented in the GUI 600, which may facilitate generation of the guided tour. For example, the guided tour menu 616 may provide a callout menu 618 with one or more callouts that may be associated with one or more of the interactive objects 604. For example, in the current embodiment, a top callout 620, a bottom callout 622, a right callout 624, and a left callout 626 are provided.

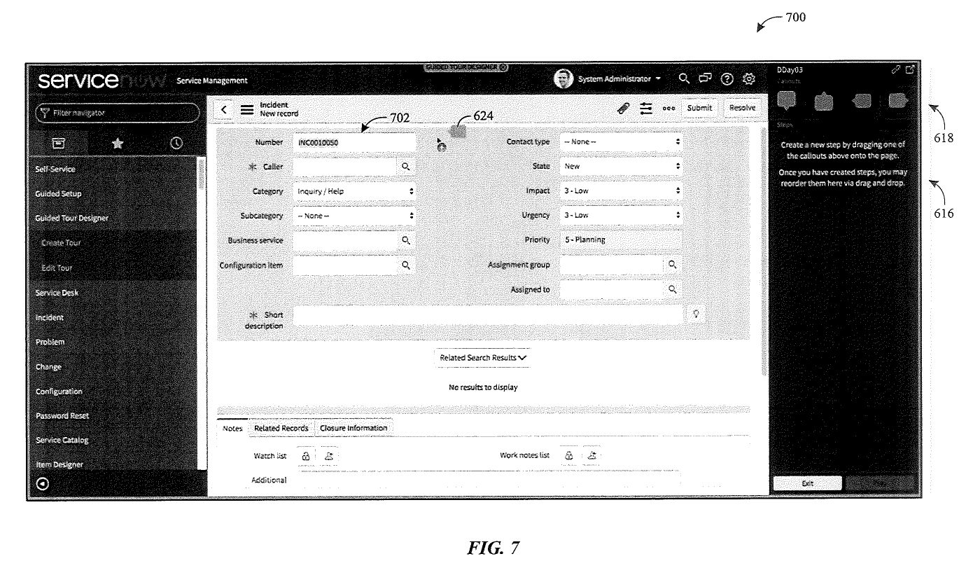

Returning to FIG. 3, the system may poll for association requests to associate a callout and an interactive object (block 310). FIG. 7 is a diagram illustrating a GUI 700 facilitating such an association request. In the GUI 700 depicted in FIG. 7, the right callout 624 is dragged from the callout menu 618 and dropped on/near the Number interactive object 702. In the current embodiment, this drag and drop action indicates an association request between an instance of the callout 624 and the Number interactive object 702. In some embodiments, an association request may be indicated in other manners, such as via a dialog box, etc.

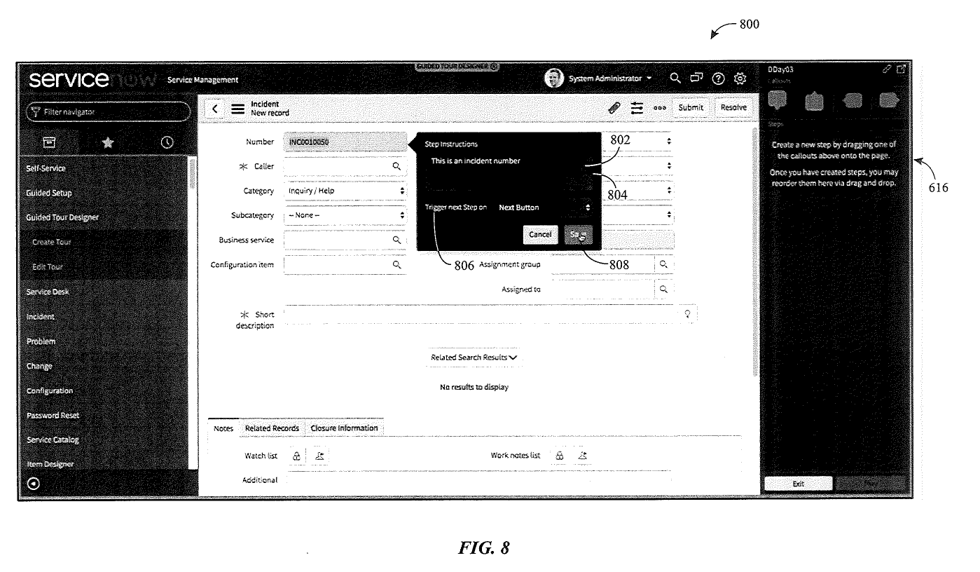

Returning to FIG. 3, upon receiving/detecting the association request, the GUI may prompt for characteristics of the callout instance (block 312). For example, FIG. 8 is a diagram illustrating a GUI 800 where a callout instance characteristic prompt 802 is provided, in accordance with an embodiment. In the current embodiment, the callout instance characteristic prompt 802 prompts for particular information relating to the callout instance (e.g., the instance of callout 624 discussed above with regard to FIG. 7) to be associated with the interactive object (e.g., the Number interactive object 702 discussed above with regard to FIG. 7). For example, a Step Instructions box 804 may be used to provide input pertaining to content (e.g., text, audio, video, etc.) that should be presented inside the corresponding callout instance. For example, in FIG. 8, the text “This is an incident number” is provided as input for subsequent presentation in the corresponding callout instance. Callout meta-data used for indicating a subject matter related to the callout may be derived by mining data derived from the step instructions box 804. Alternatively, an additional prompt may be provided, enabling manual insertion of meta-data related to the callout.

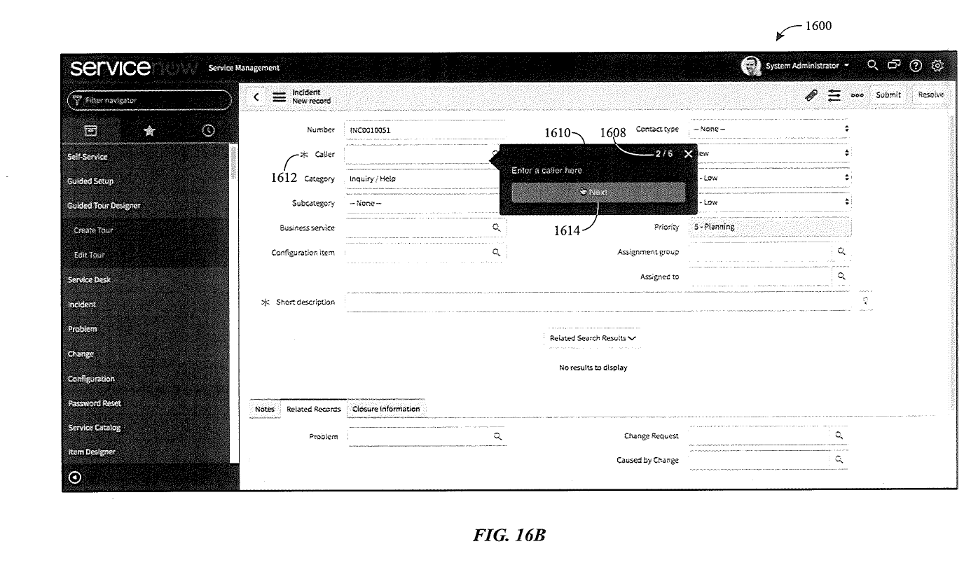

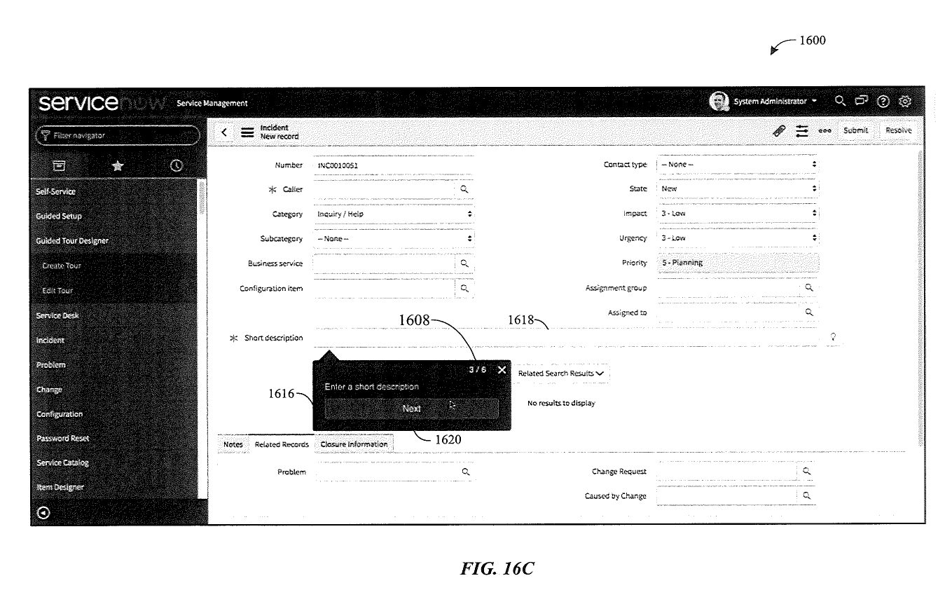

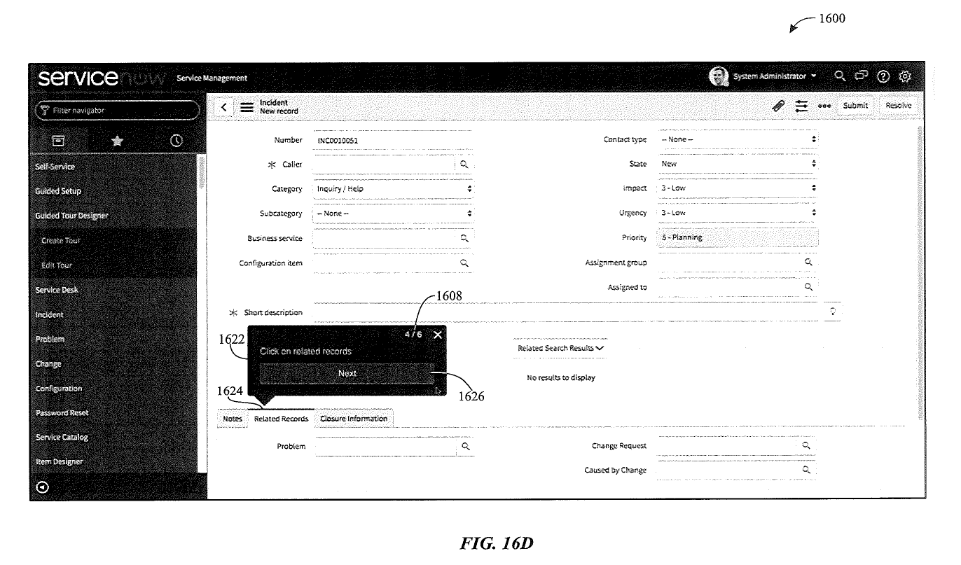

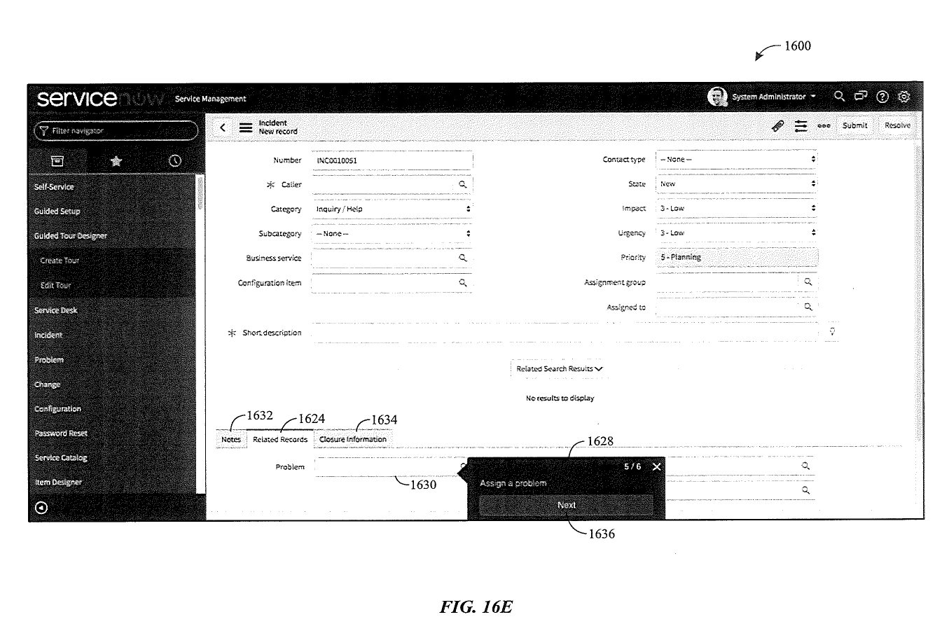

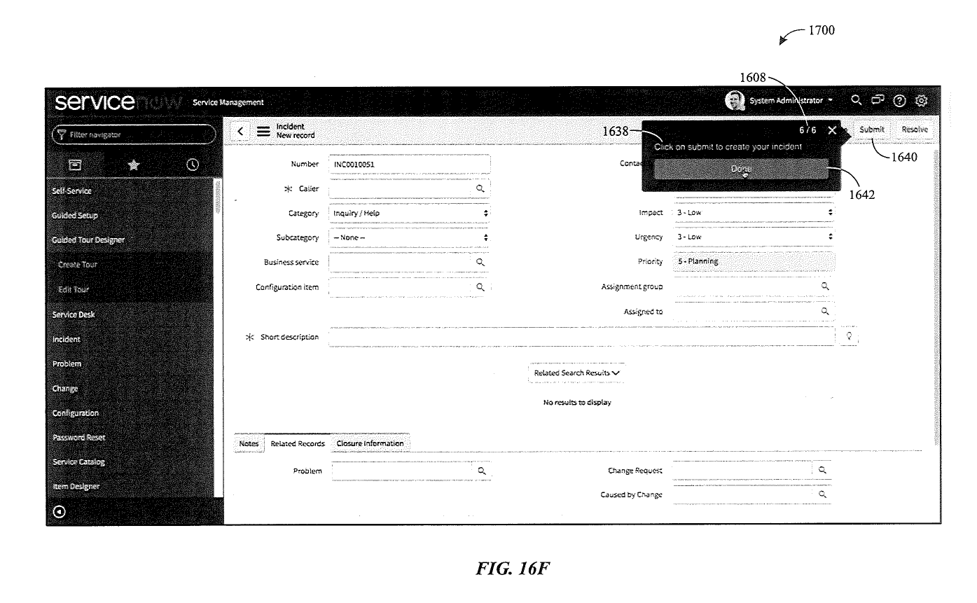

Additionally, a trigger prompt 806 may be used to gather a trigger input that determines when a subsequent callout instance will be presented. For example, in FIG. 8, a subsequent callout instance (if one is present in the guided tour) will be presented upon selection of a “Next” button. This trigger indication not only tells indicates that when the subsequent callout instance should be presented, but also indicates that the “Next” button should be presented in the current callout instance corresponding to the prompt 802. This presentation of the “Next” button may be seen in FIGS. 16A and B, as will be discussed in more detail below. Other trigger indications may be available. In some embodiments, the next callout instance may be triggered by a click within the callout instance, a click outside the callout instance, a duration of time, etc.

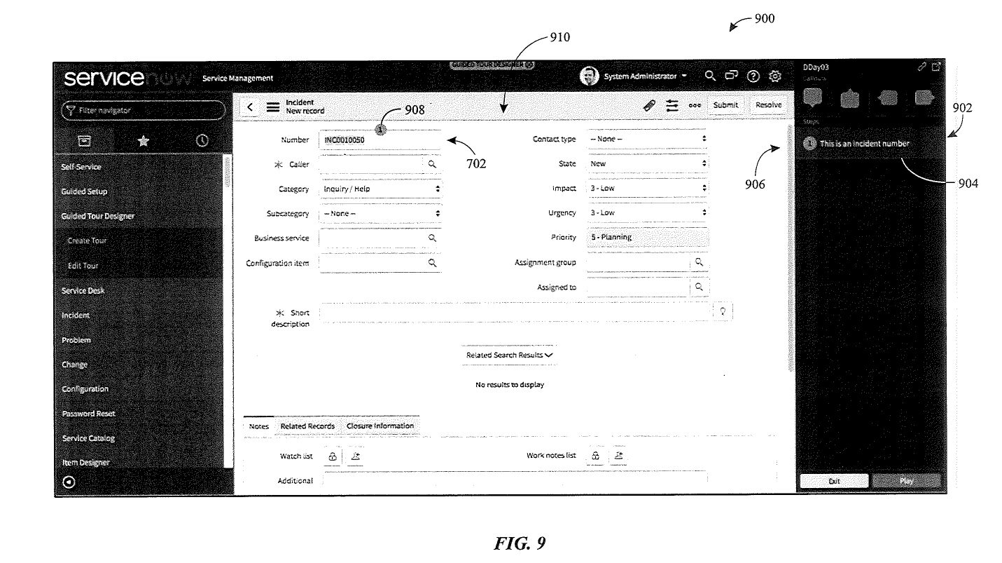

Upon completion of providing input to the callout instance characteristics prompt 802 (e.g., by selecting the “Save” button 808, the characteristics may be saved for the callout instance. Returning to FIG. 3, the process 300 may continue by generating and storing an association between the callout instance and the interactive object (block 314). For example, the callout instance and its associated characteristics and interactive object may be saved in a relational data table, for subsequent retrieval. The association may be sequentially stored, meaning that the order in which the associations are created may be tracked and stored. This order enables a proper order for subsequent display of the relevant associations. Additionally, an indication of the saved association may be visually provided by the GUI. For example, FIG. 9 is a diagram illustrating a GUI 900 where a sequentially stored association is visually provided, in accordance with an embodiment. As illustrated, after the association is stored, the guided tour menu 616 provides an indication 902 of the callout instance (e.g., by displaying the step instructions 904 of the callout instance and/or the sequence position 906 (e.g., “1”) of the callout instance). Additionally, an indicator 908 is positioned on and/or near the corresponding interactive object (e.g. the Number interactive object 702). By providing both indicators 902 and 908, a clear indication of the callout instance may be provided without bulking up the presentation of page 910 during the guided tour generation process.

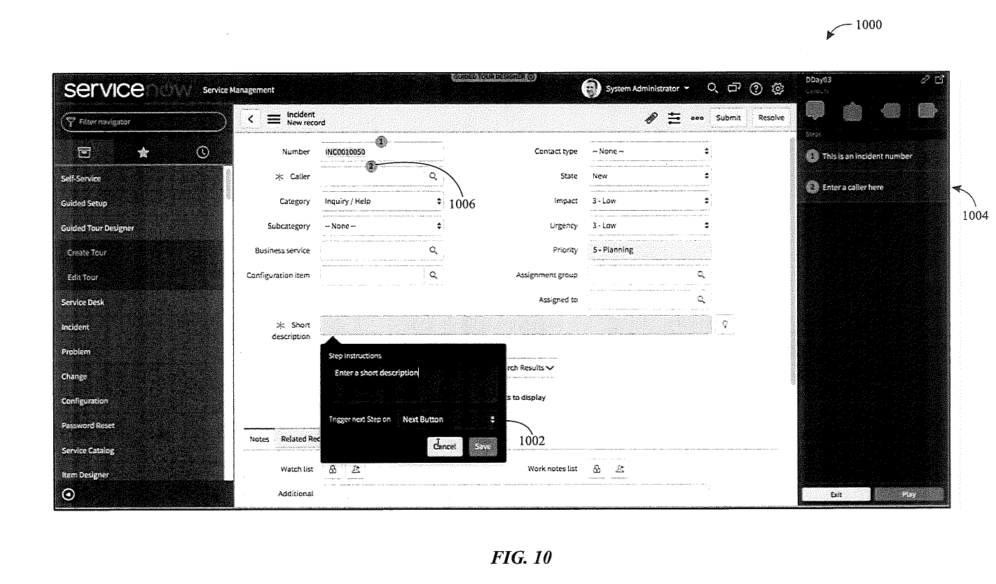

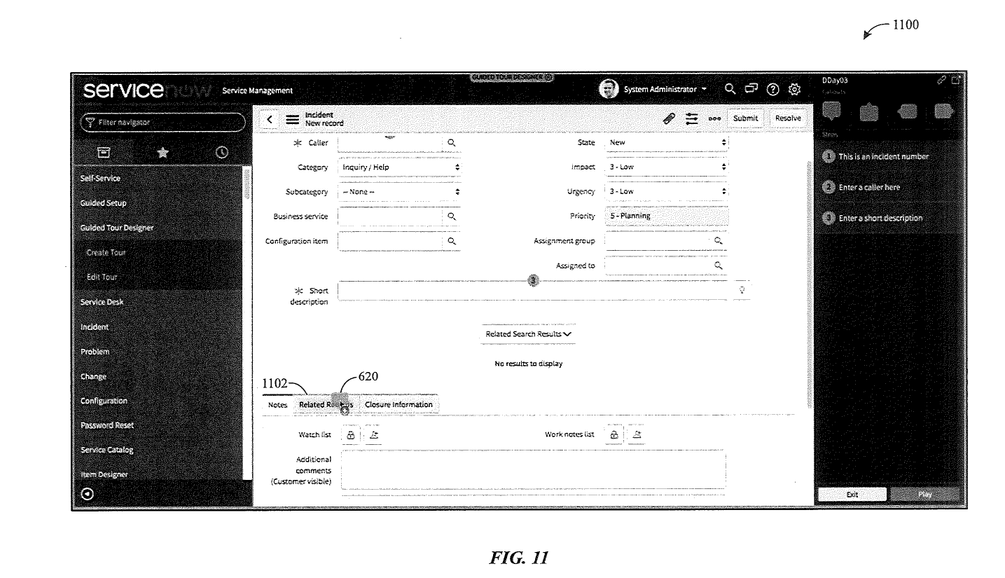

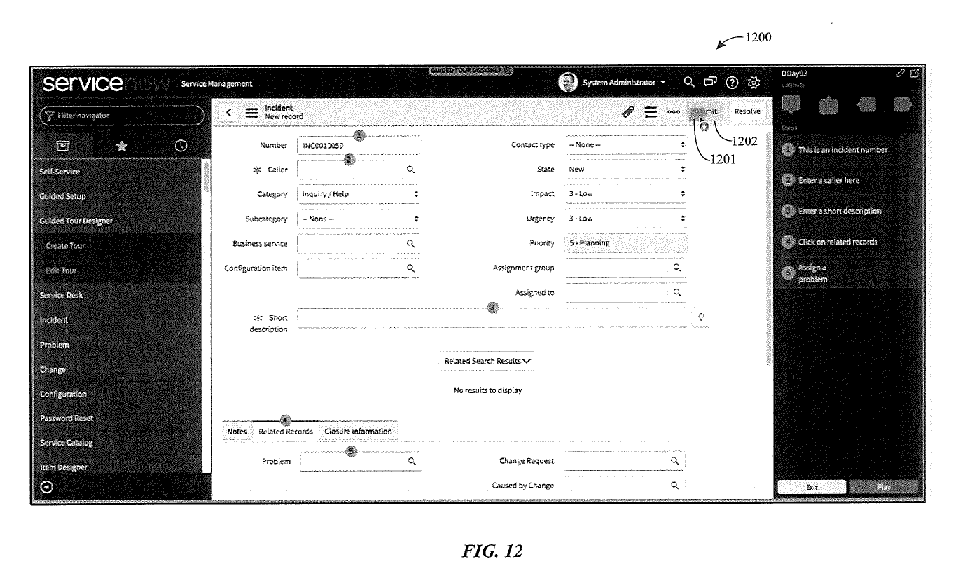

Returning to FIG. 3, process 300 continues by determining if additional association requests are detected (decision block 316). If additional association requests are detected, the process 300 iteratively repeats the tasks of blocks 310 314 until no further association results are detected (decision block 316). For example, FIG. 10 is a diagram illustrating a GUI 1000 where a third callout characteristic prompt 1002 is provided based upon a third association request, after a second association has already been generated and sequentially saved (e.g., as indicated by indicators 1004 and 1006), in accordance with an embodiment. Further, FIG. 11 is a diagram illustrating a GUI 1100 where an association request between an instance of a top callout 620 and an interactive tab 1102 is facilitated (e.g., by dragging and dropping the top callout 620 on the interactive tab 1102, in accordance with an embodiment. Additionally, FIG. 12 is a diagram illustrating a GUI 1200 where a subsequent association request between an instance 1201 of a left callout 626 and an interactive button 1202 is provided, in accordance with an embodiment.

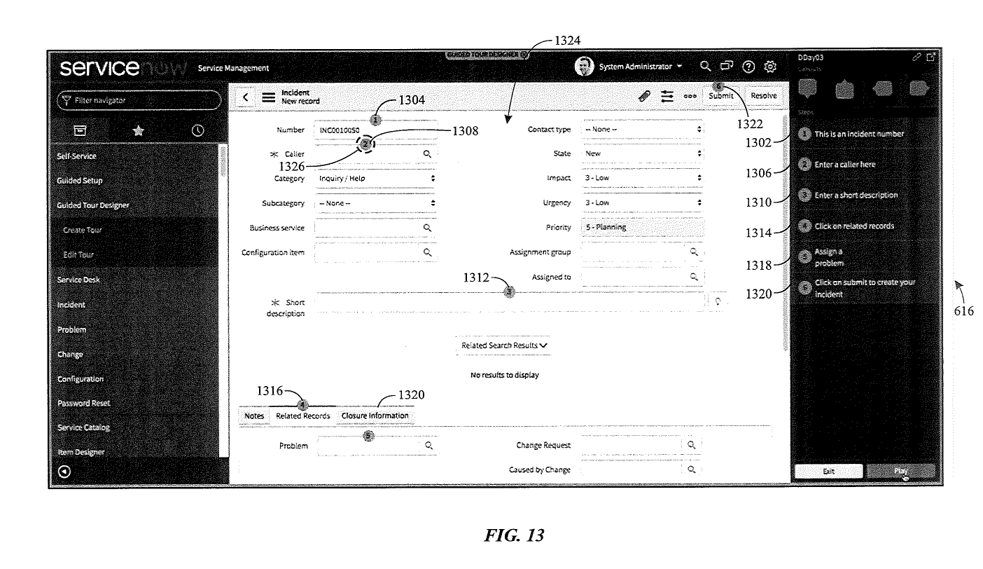

FIG. 13 is a diagram illustrating a GUI 1300 where a set of complete sequential associations are stored, as indicated by indications 1302 and 1304 for a first callout instance, indications 1306 and 1308 for a second callout instance, indications 1310 and 1312 for a third callout instance, indications 1314 and 1316 for a fourth callout instance, indications 1318 and 1320 for a fifth callout instance, and indications 1322 and 1324 for a sixth callout instance.

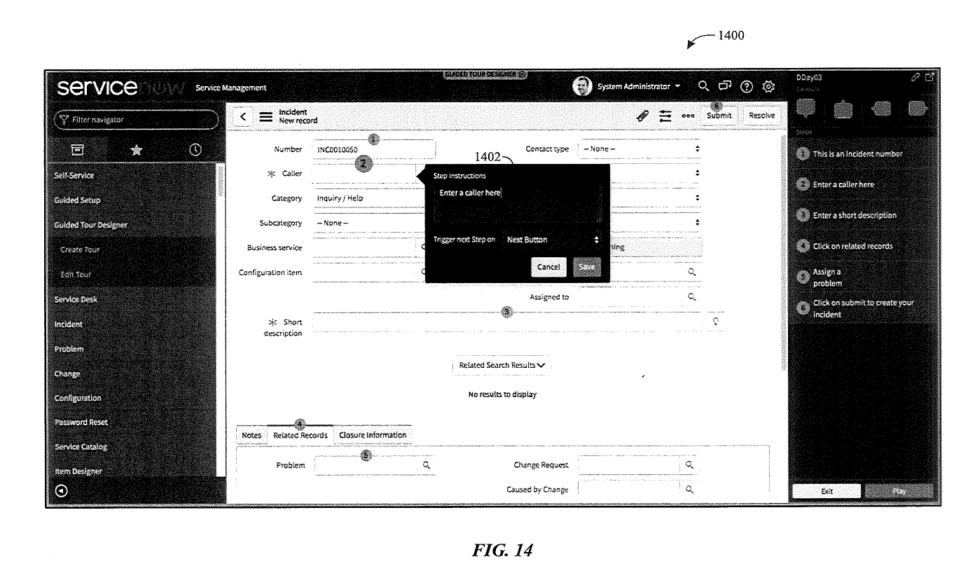

After creation of the callout instances, it may be desirable to edit one of the callout instances. In certain embodiments, hovering over one of the indications in the guided tour menu 616, may alter a corresponding indication in the page view 1324. For example, in the current embodiment, hovering over indication 1306 causes indication 1308 to enlarge, change color, or otherwise be altered (e.g., being surrounded by dashed line 1326). Conversely, hovering over an indicator in the page view 1324 (e.g., indication 1308) may, in some embodiments cause a visual alteration of a corresponding indication in the guided tour menu 616 (e.g., indication 1306). Selection of any of the indications may indicate a request to edit the corresponding callout instance. Accordingly, in some embodiments, upon selection of an indication, a callout instance characteristic edit prompt may be provided. FIG. 14 is a diagram illustrating a GUI 1400 where a callout instance characteristic edit prompt 1402 is provided after selection of one of the indicators (e.g., indicator 1306 and/or 1308) associated with a callout instance (e.g., callout instance 2), in accordance with an embodiment. As illustrated, the callout instance characteristic edit prompt 1402 may be pre-populated with previous inputs provided for the callout instance. However, the pre-populated inputs may be edited and saved, resulting in a modified callout instance.

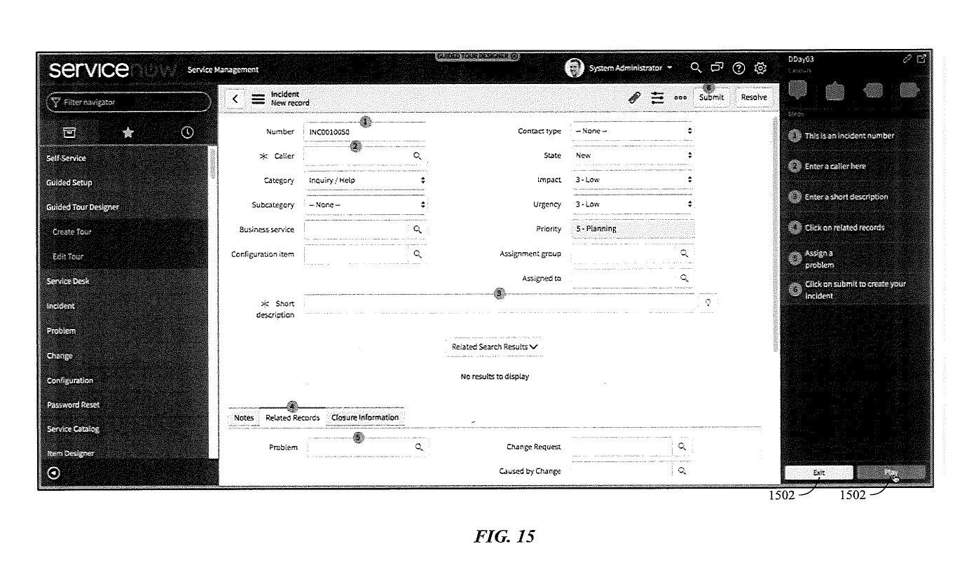

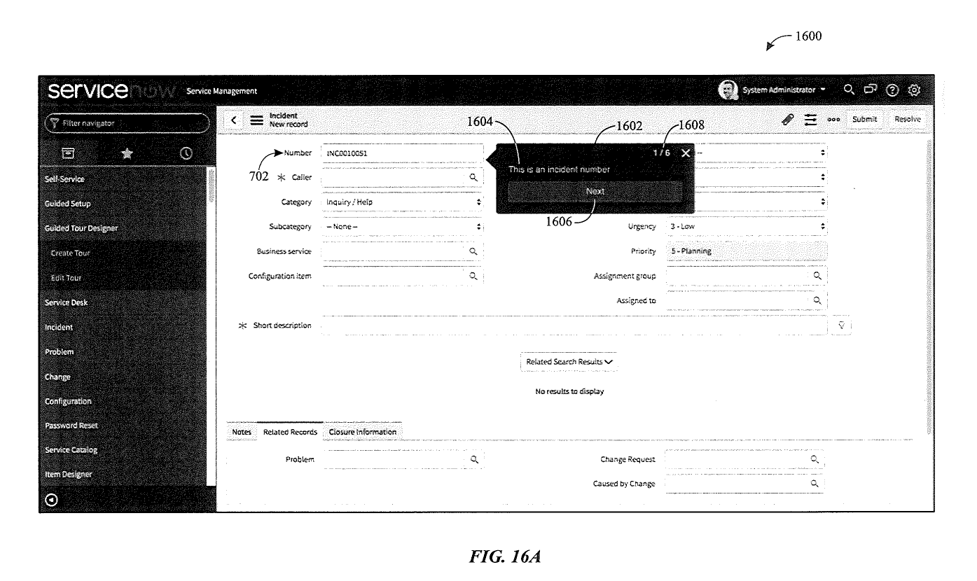

Returning to FIG. 3, the system may determine that no additional callout requests are desired (decision block 316). For example, in some embodiments, such as in the GUI 1500 of FIG. 15, such an indication may be based upon selection of an “Exit” or “Save” button 1502 and/or a “Play” button 1504. Upon selection of either of these buttons 1502 and/or 1504, a guided tour may be generated using the sequentially saved associations (block 1318).

FIGS. 16A-F are diagrams illustrating playback progression of a generated guided tour, in accordance with an embodiment. Upon presentation of the guided playback, the first callout association is presented via the GUI. FIG. 16A illustrates a GUI 1600 that presents the first callout association of the example guided tour generated in FIGS. 4-15. As illustrated, a right callout instance 1602 is provided next to the Number interactive object 702. The right callout instance 1602 includes each of the characteristics described in the callout characteristics prompt 802, including the step instructions 1604 and a next button 1606 (generated based upon the “Next Button” trigger indication of FIG. 8. Additionally, in some embodiments, a progression indicator 1608 may be presented, indicating the current callout instance (e.g., “1”) and the total number of callout instances (e.g., “6”) associated with the current guided tour.

Upon selection of the next button 1606, the second callout association 1610 is presented. For example FIG. 16B illustrates GUI 1600 now presenting the second callout association 1610 that is associated with the caller interactive object 1612. As illustrated, the progression indicator 1608 now indicates that the second callout association is being presented.

Upon selection of the next button 1614, the third callout association 1616 is presented. For example FIG. 16C illustrates GUI 1600 now presenting the third callout association 1616 that is associated with the short description interactive object 1618. As illustrated, the progression indicator 1608 now indicates that the third callout association is being presented.

Upon selection of the next button 1620, the fourth callout 1622 association is presented. For example FIG. 16D illustrates GUI 1600 now presenting the fourth callout association 1622 that is associated with the Related Records interactive tab 1624. As illustrated, the progression indicator 1608 now indicates that the fourth callout association is being presented.

Upon selection of the next button 1626, the fifth callout association 1628 is presented. For example FIG. 16E illustrates GUI 1600 now presenting the fifth callout association 1628 that is associated with the Problem field 1630. As illustrated, the Problem field is on the Related Records tab, which may be covered by the Notes tab 1632 or the Closure Information tab 1634. In some embodiments, upon progression to callout associations on covered tabs, the covered tab may be automatically selected/uncovered, enabling visualization of the relevant callout association. As illustrated, the progression indicator 1608 now indicates that the fifth callout association is being presented.

Upon selection of the next button 1636, the sixth callout association 1638 is presented. For example FIG. 16D illustrates GUI 1600 now presenting the sixth callout association 1638 that is associated with the Submit button 1640. As illustrated, the progression indicator 1608 now indicates that the sixth callout association is being presented. Further, because this is the last callout association in the guided tour, a “Done” button 1642 is provided. When clicked, the “Done” button 1642 ends the guided tour.

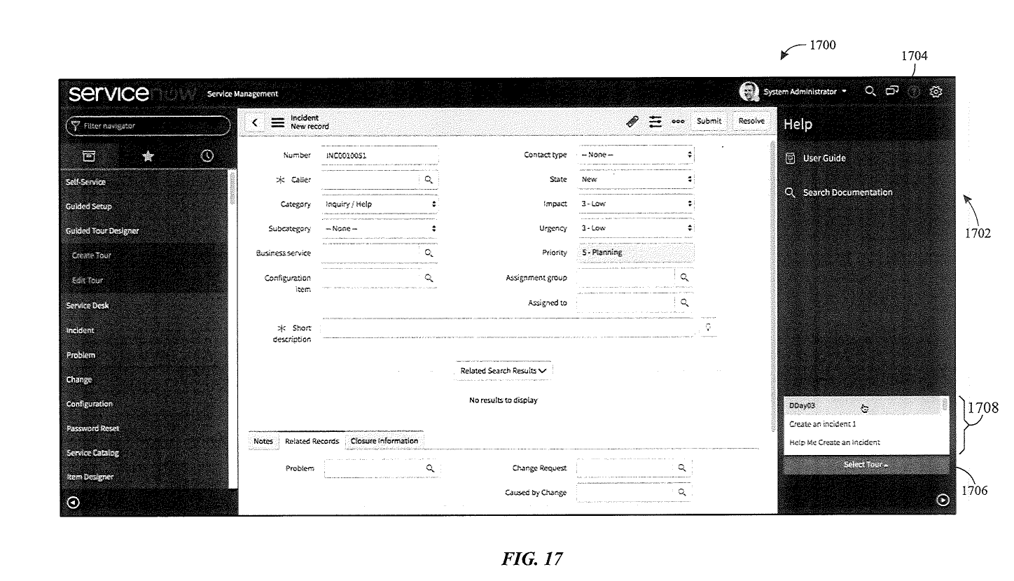

Once the guided tour is created, it may be automatically added to an embedded help dialog. FIG. 17 is a diagram illustrating a GUI 1700 where previously presented guided tour is automatically incorporated into an embedded help section of the application, in accordance with an embodiment. In the GUI 1700, the embedded help dialog box 1702 is presented (e.g., in response to selecting a help request icon 1704). The embedded help dialog box 1702 includes a guided tour selection button 1706 that, when selected polls for saved guided tours that are available for the roles of the currently logged in user (e.g., as determined based upon the Roles section 508 of FIG. 5) and presents the saved guided tours in a list 1708. As illustrated, the previously generated guided tour, named “DDay03”, is presented in the list 1708. Upon selection of one of the guided tours from the list, the guided tour is played for the user, facilitating assistance with complex activities in the GUI.

### Digital Document Presentation

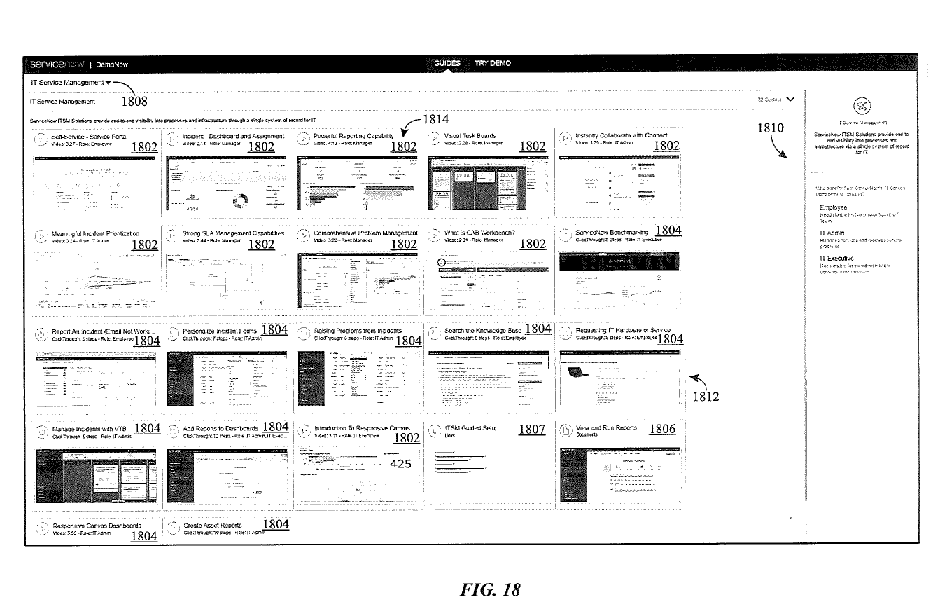

As mentioned above, other interactions with digital content may be monitored to determine relevant digital content/focus areas. FIG. 18 is a block diagram illustrating a GUI 1800 of a digital content offering portal for providing digital content (e.g., videos 1802, click through demonstrations 1804, and digital documents 1806) in accordance with an embodiment. The GUI 1800 may recommend digital content (e.g., videos 1802, click through demonstrations 1804, digital documents 1806, and hyperlinks 1807) based at least in part upon a classification of a user and/or prior interaction with digital content. In some embodiments, an initial set of digital content may be provided when there is not sufficient prior data available to provide accurate recommendations (e.g., the user has not previously interacted with digital content and/or has not provided any classification information).

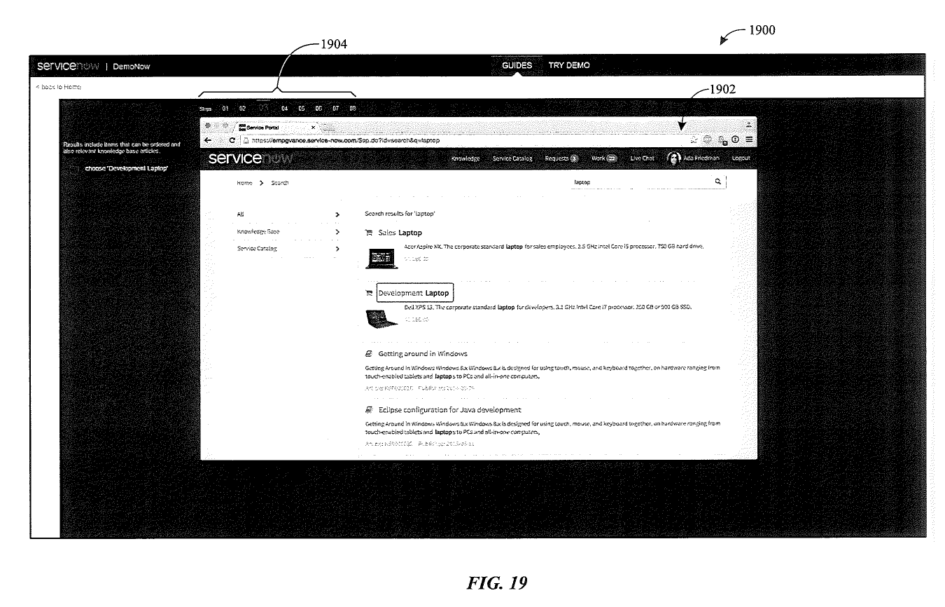

FIG. 19 is a block diagram illustrating a GUI 1900 for providing a click-through demonstration, in accordance with an embodiment. The click-through demonstration may provide a set of slides (e.g., Step 3 slide 1902) illustrating a click-through path of set of steps 1904 for a particular demonstrated feature. For example, in GUI 1900, Step 3 slide 1902 illustrates a third step of the eight steps 1904 of the click-through demonstration. As mentioned above, certain interaction characteristics may be monitored, which may provide support for discerning a relevant focus area and/or relevant content for the interactor. For example, meta-data associated with the click-through demonstration may indicate a particular area of interest of the interactor. For example, to reach the eight step click-through demonstration, the interactor may have selected the “Requesting IT Hardware of Service” click-through demonstration selection 1812 of FIG. 18. Accordingly, meta-data indicating characteristics associated with IT hardware or Services may be associated with the click-through demonstration. Further, repeating the click-through demonstration and/or a speed of clicking-through the demonstration may be observed and/or used to facilitate determination of focus area/relevant content. For example, as mentioned above, fast click-through may indicate an expert user, while slow click-through may indicate a beginner user. Further, repetitive interaction with the click-through demonstration may indicate a particular interest by the interactor.

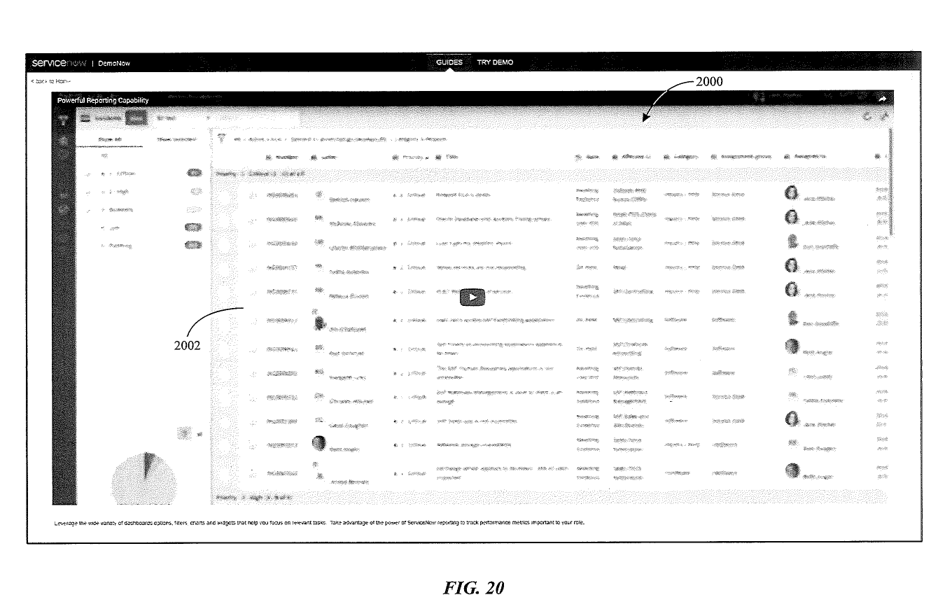

Video interaction may also be used for focus area/relevant content determination. FIG. 20 is a block diagram illustrating a GUI 2000 for providing video digital content 2002, in accordance with an embodiment. The GUI 2000 may be reached by selecting the “Powerful Reporting Capability” video selection 1814 of FIG. 18. As mentioned above, many interaction characteristics may be used to facilitate determination of focus area/relevant content of the interactor. For example, the number of times a video is repeated (or a portion of the video is repeated) may indicate a magnitude of interest in the video's topic. The video's topic (or a portion of the video's topic) may be ascertained by the system using associated machine-readable meta-data. Multiple different meta-data may be provided for various portions of the video, providing an indication of different subject matter for portions of the video. Further, a duration of playback and/or whether the video was played to completion may provide an indication of interest in the video's subject matter.

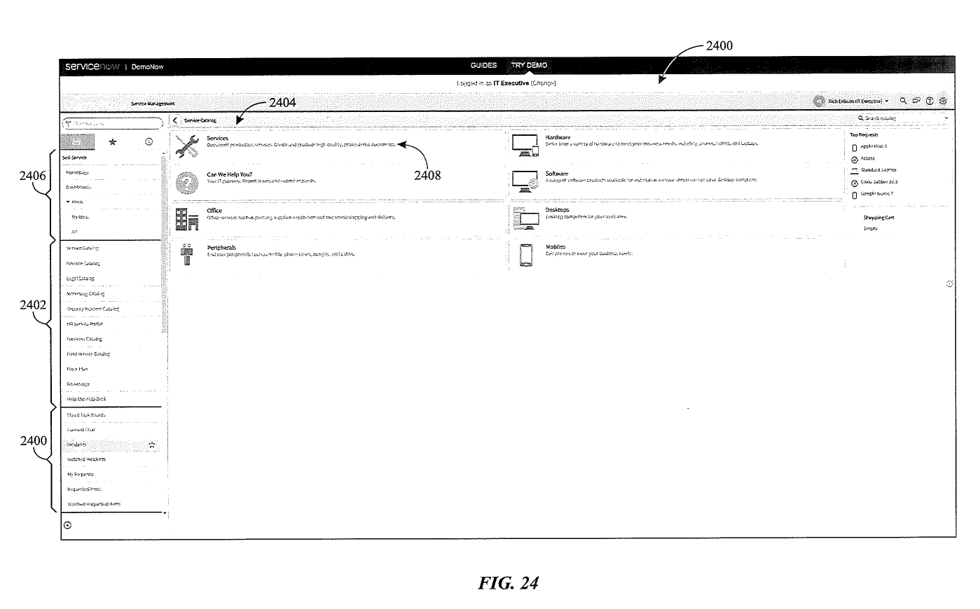

Demonstration application interaction may also be used for focus area/relevant content determination. FIG. 24 is a block diagram illustrating a GUI 2400 for providing a demonstration instance, in accordance with an embodiment. The GUI 2400 may provide a fully and/or partially functioning demonstration instance. The GUI 2400 may provide a navigation panel 2402 that provides access to various features of the demonstration. For example, in FIG. 24, the Service Catalog 2404 is presented (e.g., based upon selection in the navigation panel 2402). Additional features may also be provided based upon selection from alternative navigation panels 2406. As the interactor progresses through portions of the demonstration, interactions with the demonstration may be recorded. The characteristics of the interaction may be used in determining focus areas/relevant content of the interactor. For example, if the interactor navigates to particular portions of the demonstration (e.g., the Service Catalog), it may be determined that the interactor has an interest in the navigated-to feature (e.g., the Service Catalog). Additionally, navigation to sub-components (e.g., the Services 2408 of the Service Catalog 2404) may be used to discern a more-granular focus area/relevant content. An amount of time spent on a particular feature may be used in discerning interest, as above. Further, additional interactions may be useful. For example, if the interactor performs a set of steps that results in unintended results (e.g., an error), the user may have an enhanced interest in the subject matter where the error occurred.

Returning to FIG. 18, in some embodiments, a particular subject matter of interest may be selected. For example, selector 1808 allows for various portions of the services (e.g., IT Service Management) to be selected. Upon selection by the selector 1808, the digital content may be further filtered to provide only content relevant to the selected subject matter.

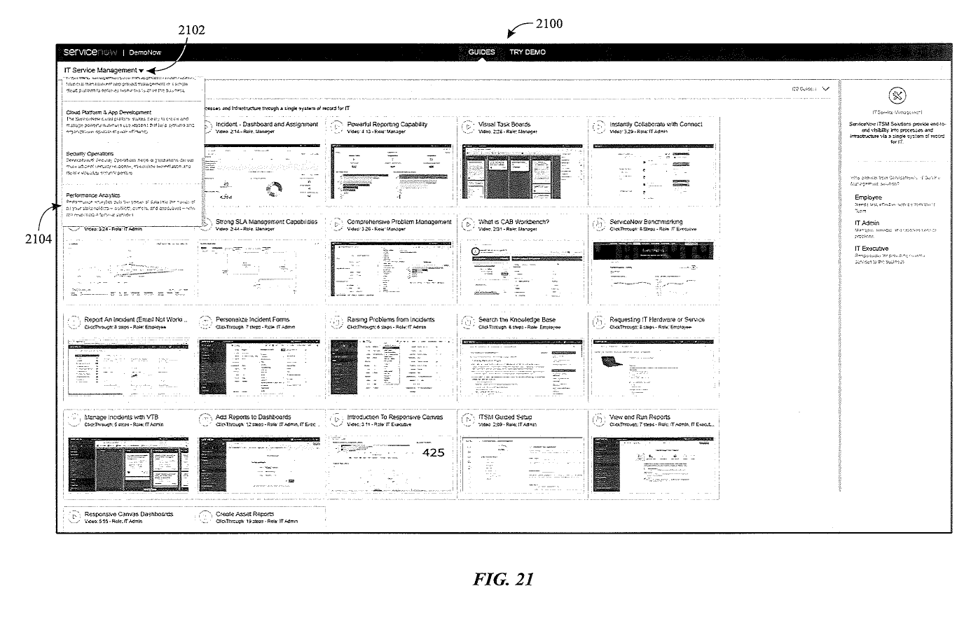

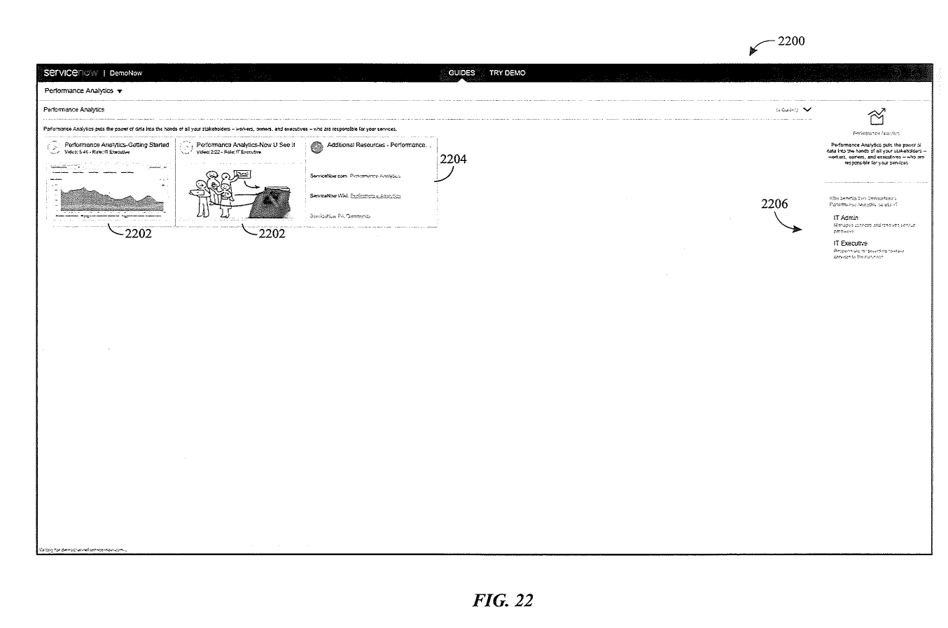

FIG. 21 is a block diagrams illustrating a GUI 2100 transitioning from an IT Service Management subject matter 2102 to a Performance Analytics subject matter 2104. Upon selecting the Performance Analytics subject matter 2104, the offered digital content transitions to digital content related to Performance Analytics, as illustrated by GUI 2200 of FIG. 22. As illustrated in GUI 2200, the previously offered digital content is removed, offering up Performance Analytics videos 2202 and Performance Analytics Additional Resource content (e.g., location hyperlinks) 2204 (e.g., to a related wiki, webpage, and/or forum/online community).

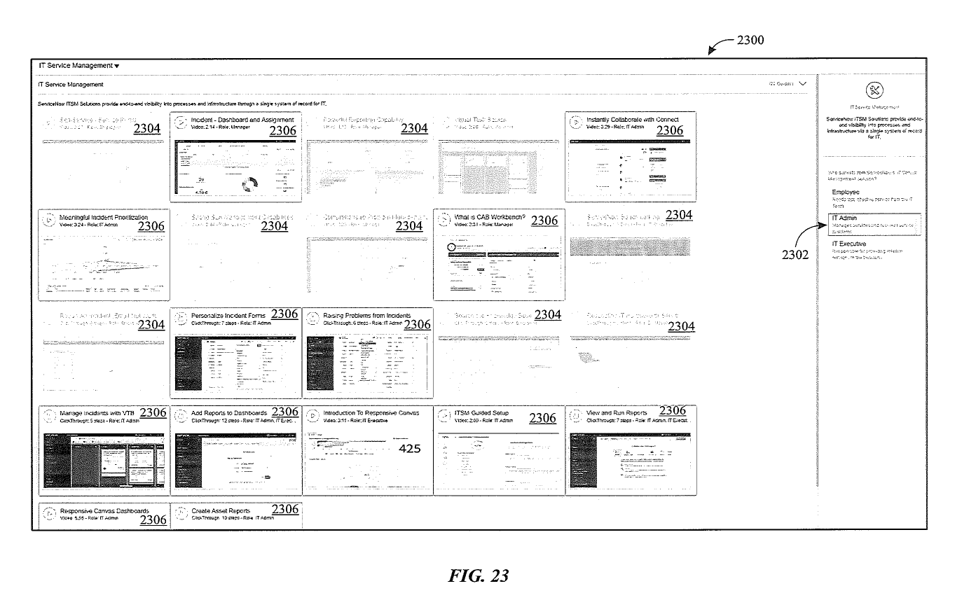

Returning to FIG. 18, as mentioned above, a user's role may also be discerned and used to classify an interactor. The digital content offerings may be filtered based upon this role-based classification. For example, if a user is an administrator, administration-based digital content may be provided. In some embodiments, when a particular role may desire to see content related to other roles (e.g., an administrator wants to see features for the employees it supports), a role prompt 1810 may also be provided. The role prompt may be used to filter digital content associated with the selected role of the role prompt. FIG. 23 is a block diagram illustrating a GUI 2300 that filters digital content based upon a selected role 2302 for providing role-based digital content, in accordance with an embodiment. In some embodiments, as illustrated in FIG. 23, the digital content not associated with the selected role (e.g., digital content 2304) may remain offered, but set apart as not matching the selected role (e.g., via grey out, etc.). In alternative embodiments, the digital content 2304 may be removed from being offered, leaving only the role-relevant digital content 2306. Further, the subject matter selection may also impact the available roles. As illustrated in the roles prompt 2206 of GUI 2200, the Employee role has been removed when presenting Performance Analytics subject matter 2104, because, in the current embodiment, employees do not run Performance Analytics functions.

Using the above-described techniques, content provision/recommendation may be facilitated GUI interaction, resulting in significant improvement in customer satisfaction and support. Further, interactive objects of application pages may be easily and efficiently featured for demonstration and/or embedded help purposes.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A tangible, non-transitory, machine-readable medium, comprising machine-readable instructions, to:
render a graphical-user-interface (GUI), the GUI comprising a plurality of interactive objects;
receive a request to generate a guided tour of the plurality of interactive objects;
upon receiving the request:
provide a callout menu, the callout menu comprising one or more callouts that may be associated with the plurality of interactive objects;
iteratively:
receive a request to associate one of the one or more callouts with one of the plurality of interactive objects; and
generate an association by associating the one of the one or more callouts with the one of the plurality of interactive objects, sequentially storing an association indication in a data store, such that a sequence of association indications is maintained;
generate a guided tour for the plurality of interactive objects, using the sequence of indications, the guided tour providing a sequence of associated callouts for the plurality of interactive objects upon a subsequent rendering of the plurality of interactive objects;
apply meta-data to the guided tour, the meta-data providing an indication of subject matter of the guided tour, at least one of the one or more callouts, or both;
upon subsequent playback of the guided tour:
access the meta-data to identify a focus area based upon the indication of subject matter of the guided tour; and
generate one or more future content recommendations based upon the focus area.

2. The machine-readable medium of claim 1, comprising instructions to:
receive an indication of a page associated with the plurality of interactive objects; and
render the GUI comprising the plurality of interactive objects based upon the indication of the page associated with the plurality of interactive objects.

3. The machine-readable medium of claim 1, comprising instructions to:
receive the request to associate one of the one or more callouts with the one of the plurality of interactive objects via a drag and drop of a callout to the one of the one or more callouts.

4. The machine-readable medium of claim 1, comprising instructions to:
upon receiving the request to associate one of the one or more callouts with the one of the plurality of interactive objects, provide a prompt to receive step instructions for the one of the one or more callouts, wherein the meta-data is derived from the step instructions.

5. The machine-readable medium of claim 4, comprising instructions to:
present the guided tour by displaying the step instructions inside the one of the one or more callouts.

6. The machine-readable medium of claim 1, comprising instructions to:
upon receiving the request to associate one of the one or more callouts with the one of the plurality of interactive objects, provide a prompt for the meta-data and provide a prompt to receive a trigger for a subsequent callout.

7. The machine-readable medium of claim 6, comprising instructions to:
present the guided tour presenting the subsequent callout based upon the trigger.

8. The machine-readable medium of claim 6, wherein the trigger comprises:
selection of a button, selection inside the callout, selection outside the callout, or a time duration.

9. The machine-readable medium of claim 1, wherein the interactive object comprises a text field, an interactive tab, a selection list, a button, or any combination thereof.

10. The machine-readable medium of claim 1, comprising instructions to:
visually provide, via the GUI, a sequential listing of the sequence of association indications.

11. The machine-readable medium of claim 10, comprising instructions to:
visually provide, via the GUI, corresponding indicators in a page visualization that correspond to the sequential listing of the sequence of association indicators.

12. The machine-readable medium of claim 11, comprising instructions to:
visually alter, via the GUI, one of the corresponding indicators in the page visualization when hovering over a corresponding one of association indicators in the sequential listing of the sequence of association indicators.

13. The machine-readable medium of claim 11, comprising instructions to:
detect a selection of one of the corresponding indicators in the page visualization or one of the association indicators in the sequential listing of the sequence of association indicators;
upon detection of the selection, present a characteristic editing box for a corresponding one of the callouts that corresponds to the selection, such that characteristics of the corresponding one of the callouts may be edited.

14. A tangible, non-transitory, machine-readable medium, comprising machine-readable instructions, to:
identify, via interactivity analysis services running on a computer hardware processor, an interactor interacting with a plurality of digital content;
determine a classification of the interactor, via the interactivity analysis services;
identify and accumulate, via the interactivity analysis services:
interactions between the interactor and at least a portion of the plurality of digital content; and
one or more characteristics of the interactions;
identify meta-data associated with the interactions;
determine a weighted distribution of the meta-data by weighting the meta-data based upon the one or more characteristics of the interactions;
identify a focus area of the interactor based upon the weighted distribution of the meta-data and the classification of the interactor; and
provide notification of the focus area, present digital content offerings related to the focus area, or any combination thereof.

15. The machine-readable medium of claim 14, comprising instructions to:
determine the weighted distribution of the meta-data by weighting the meta-data based upon:
a duration of time of interaction between the interactor and the at least a portion of the plurality of digital content;
whether the at least a portion of the plurality of digital content was played back to completion;
whether the at least a portion of the plurality of digital content was repeated;
or any combination thereof.

16. The machine-readable medium of claim 14, comprising instructions to:
determine the classification of the interactor by:
identifying a role of the interactor;
determining whether the interactor is a current customer, a current partner, a potential customer, a potential partner, or any combination thereof;
or any combination thereof.

17. The machine-readable medium of claim 14, wherein the at least a portion of the plurality of digital content comprises a click-through demonstration, a guided tour, or a combination thereof.

18. The machine-readable medium of claim 14, wherein the at least a portion of the plurality of digital content comprises a video, wherein the meta-data comprises a plurality of meta-data indicating subject matter at various portions of the video.

19. A system, comprising one or more processor, configured to:
identify, via interactivity analysis services running on a computer hardware processor, an interactor interacting with a plurality of digital content;
determine a classification of the interactor, via the interactivity analysis services;
identify and accumulate, via the interactivity analysis services:
interactions between the interactor and at least a portion of the plurality of digital content; and
one or more characteristics of the interactions;
identify meta-data associated with the interactions;
determine a weighted distribution of the meta-data by weighting the meta-data based upon the one or more characteristics of the interactions;
identify a focus area of the interactor based upon the weighted distribution of the meta-data and the classification of the interactor; and
provide notification of the focus area, present digital content offerings related to the focus area, or any combination thereof.

20. The system of claim 19, wherein the one or more processors are configured to:
provide the notification of the focus area to a sales representative, customer service representative, or both.

21. The system of claim 19, wherein the one or more processors are configured to:
present the digital content offerings related to the focus area via a digital content offering portal.

22. A system, comprising: a non-transitory memory and one or more hardware processors configured to read instructions from the non-transitory memory to perform operations comprising:
providing a designer interface of at least one incident record;
determining a plurality of fields selected from the at least one incident record based at least on a respective callout interaction with each of the plurality of selected fields;
generating a respective callout for at least a subset of the plurality of selected fields based at least on the respective callout interactions, wherein the respective callouts are configurable with the designer interface;
generating a plurality of steps corresponding to the at least subset of the plurality of selected fields and the respective callouts; and
providing a guided tour with the at least subset of the plurality of steps that display the respective callouts, wherein the plurality of steps are configured to modify the respective callouts.
